(19) United States
(12) Patent Application Publication
(10) Pub. No.: US 2013/0264726 A1
(43) Pub. Date: Oct. 10, 2013

(54) Nitride Nuclear Fuel and Method for Its Production

(71) Applicants: Janne Wallenius, Marsta (SE); Mohamed Radwan, Bromma (SE); Mikael Jolkkonen, Uppsala (SE)

(72) Inventors: Janne Wallenius, Marsta (SE); Mohamed Radwan, Bromma (SE); Mikael Jolkkonen, Uppsala (SE)

(73) Assignee: DIAMORPH AB, Stockholm (SE)

(21) Appl. No.: 13/876,202

(22) PCT Filed: Sep. 27, 2011
(86) PCT No.: PCT/SE2011/051149

§ 371 Date: Jun. 19, 2013

Related U.S. Application Data
(60) Provisional application No. 61/386,804, filed on Sep. 27, 2010.

(51) Int. Cl. G21C 21/00

(52) U.S. Cl. CPC G21C 21/00
USPC 264/5

(57) ABSTRACT

The invention relates to a nitride nuclear fuel characterized in that the nitride fuel is a pellet of a material with a single-phase solid solution of elements comprising at least a nitride of americium (Am), and that the material has a density of around 90% of the theoretical density. The invention further relates to a method for producing the said nuclear fuel by using the steps: mixing of starting powders, sintering of the powders into a dense pellet and a subsequent heat treatment.

### TECHNICAL FIELD

The present invention relates generally to nitride nuclear fuels and a method for producing nitride fuels to be used as nuclear fuel in nuclear reactors. The materials considered for this fuel are (U,Pu,Am)N, (U,Pu,Am,Cm)N, (U,Pu,Am,Zr)N and (U,Pu,Am,Cm,Zr)N. The production method is a combination of spark plasma sintering and a thermal treatment step.

### BACKGROUND ART

New nuclear fuels are needed for future generations of nuclear reactors; in order to minimize the nuclear waste, secure the availability of the fuel in the future and to increase the safety of the nuclear reactors.

Plutonium and americium are the largest contributors to the long lived radio-toxicity in spent fuel from nuclear power plants. See FIG. 1, which discloses a graph over the radiotoxic inventory of some radiotoxic isotopes over time. These long-lived waste products must today be stored in geologically isolated repositories for their radio toxic lifetime.

In order to utilize these still energy rich waste product, they can be considered as potential fuel and used in the new and more effective Generation IV reactors. Thus, some of the isotopes, such as americium and curium, can be incorporated and reused in the Generation IV fuel pellets. Thereby the radiotoxic waste product can be turned into less hazardous materials while providing extra energy in the process. However, reliable and simple production methods for this fuel have been missing.

Current reactors use either uranium dioxide or a mix of uranium dioxide and plutonium dioxide. The fuel powder is pressed into pellets and the pellets are then inserted into thin tubes to form rods, which are used as fuel. However, Generation IV nitride nuclear fuel, such as (U,Pu,Am)N, (U,Pu,Am,Cm)N, (U,Pu,Am,Zr)N and (U,Pu,Am,Cm,Zr)N, cannot be sintered with conventional methods, as americium nitride, AmN, dissociates and evaporates at high temperatures, such as 1800 Kat 1 bar nitrogen pressure. Volatilization of minor actinides, such as Am, is a problem in the fuel production. The volatilization is temperature dependent. It is thus desirable to lower the sintering temperature.

The spark plasma sintering method (SFS), also referred to as for example field assisted sintering technique (FAST), is a powerful sintering technique which allows very rapid heating under high mechanical pressures, for consolidation of powders into solid component. This process, hereafter referred to as SFS, is very suitable for production of highly dense components. The process is also suitable for production of component with tailored porosities and a well-controlled microstructure. The sample density depends on the sintering temperature and pressure. Compared to conventional sintering methods, SFS results in limited grain growth and smaller pores, due to the rapid sintering and high pressure, and over all the process offers an easy densification without the needed addition of sintering additives.

With the SFS technology it is possible to lower the sintering temperature, as SFS is generally known to employ lower sintering temperatures than conventional sintering methods, while still obtaining very good densification. The SFS process is further giving a favorable high density of the sintered component. However, the SFS process alone does not give a desired solid solution of the present substances of this invention. The solid solution is the active phase in the nuclear fuel and it is also crucial to stabilize the AmN, as it suppresses its volatility. It is therefore needed a high density solid solution fuel pellet including Am and a method to create such a pellet.

PCT patent application WO 2007/011382 describes a fuel element for nuclear reactors comprising modified nitride uranium and nitride plutonium with additives, and a method for production of such a fuel. The nitrides are added to enhance compactness, long-life, proliferation resistance, fuel safety and waste management properties. However, the problem with volatilization of the minor actinides it not disclosed in this document.

The SFS sintering of uranium nitride is described by Muta et al. in J. Mater. Sci, 2008, 43, 6429-6434. However, the resulting pellet by Muta et al. is not in the single phase solid solution state. Thus, when used as nuclear fuel in a nuclear fuel reactor the heat release in the pellet is non-homogeneous and can give rise to unwanted heat peaks.

Production of a solid solution of transuranium nitrides through a several step method was described by Takano et al. in Wurnal of Nuclear Materials, 2009, 389, 89-92. The solid solution pellet described by Takano et al. is produced by compaction under a certain pressure and then heat treated to yield the solid solution state. Compaction is done at room temperature and the resulting pellet can never reach a density over 70%. Thus, a part of AmN was evaporated during the heat treatments.

Production of nitride fuels is also described by Voit et al. in Proceedings of GLOBAL 2005, Paper 489. In their approach a (Pu, AM, Zr)N solution is formed as a powder, and thereafter sintered, together with sintering binders, into a pellet Effort was made to reduce the volatilization of Am in the fuel, however, the result was still a loss of over 25%.

### SUMMARY OF INVENTION

An object of the present invention is to create a new nitride nuclear fuel for future Generation IV nuclear reactors, which will be a crucial part for future reactors with a higher safety and lower waste than today's reactors. A further object of the invention is to create a method for producing this fuel. The materials considered for this invention are nitrides of uranium (U), plutonium (Pu), americium (Am), curium (Cm) and zirconium (Zr), preferably in the combinations (U,Pu,Am)N, (U,Pu,Am,Cm)N, (U,Pu,Am,Zr)N and (U,Pu,Am,Cm,Zr)N.

The fuel is intended for nuclear reactors, especially fast spectrum reactors such as FBR, FR, IMFBR, IMR, ADS, ATW, ADSR etc. The main reasons for this fuel to be successful are the high thermal conductivity, the high melting point and the wide solubility between the present substances. Increased thermal conductivity improves the utility of a nuclear fuel.

According to the invention, the inventive nitride nuclear fuel comprises a pellet of a material with a single-phase solid solution of elements comprising at least a nitride of americium (Am), and that the material has a density of at least 90% and possibly up to 95%, of its theoretical density. Slightly lower density such as 85-90% of the theoretical density can also in some cases be of interest The porn sky in the pellets is desired because two fission product are created in each fission. The average volume occupied by the solid fission pm duct is larger than that of the fissioned actinide atom, leading to an estimated solid fission product swelling of 0.5% per percent fission. Moreover, gaseous fission product may accumulate into bubbles, which lead to an additional swelling, which is highly temperature dependent The porosity introduced should be able to accommodate the swelling predicted for the target burn up at the operational temperature of the fuel.

This pellet can be used directly as the active phase in the nuclear fuel and it also recycles the volatile actinide nitride Am, which was earlier declared as a nuclear waste product Its solid solution state stabilizes the AmN and with a stable AmN the density of the pellet is as high as around 90% to 95% of the theoretical density. The desired density is depending on the power rating applied to the fuel in the reactor.

In a first embodiment of the invention, the material is a nitride comprising elements belonging to the group of U, Pu, Am, Cm, Zr.

Nitrides of uranium, plutonium, zirconium and the minor actinide Am, Cm are considered to be good candidates as nuclear fuels for nuclear reactors, especially fast spectrum reactors. By using also the waste product Pu and Am, more energy can be extracted from the original fuel. Further, when using ZrN in a nuclear fuel the actinide nitrides do not dissociate as easily as when ZrN is not present

In a further embodiment, the material originates from a starting powder comprising metals, nitrates or oxides of the different elements, converted to nitrides of the elements. Preferably, the particle size of the starting powder is on the micrometer scale below 100 μm, preferably below 70 μm.

Using a powder with a smaller dimension generally enables making the sintering at a lower sintering temperature, and is thus favorable.

The invention also relates to a method for producing the nuclear fuel according to any of the above mentioned embodiments. The method comprises the following steps:
Mixing of starting powders
Sintering of the powders into a pellet
Heat treatment

When combining sintering and heat treatment it is possible to create the inventive high density nuclear fuel pellet with a single-phase solid solution.

Ina first embodiment of the method the sintering method involves current assisted compaction at a high pressure, preferably spark plasma sintering (SFS).

Current or electric pulse assisted compaction includes processes based on heating the material to be sintered with a current, preferably a pulsed DC current Other names commonly used for this technique are spark plasma sintering (SFS), pulsed electric current sintering (PECS), field assisted sintering technique (FAST), plasma-assisted sintering (PAS) and plasma pressure compaction (P₂C). These technologies will in this document hereafter be referred to as SFS. In SFS a uniaxial pressure is applied while the sample is being heated. The heating occurs through electrical energy pulses that are applied to the powder which is placed in a conductive die between conductive punches. When using the SFS technology it is possible to lower the sintering temperature, while still obtaining very good densification.

In a preferred embodiment, the sintering takes place at a temperature of maximum 1800 K.

Since americium nitride, AmN, dissociates and evaporates at temperatures over 1800 K the sintering shall preferably take place at a temperature below that.

In another embodiment, the sintering takes place under a pressure of 30-100 MPa, for a holding time of approximately 2-30 min, preferably 2-15 min.

When sintering under these preferences the resulting pellet obtains a high density and no loss of volatile actinides occur.

In another embodiment, the sintering takes place in an electronically conductive sintering die.

In another embodiment the sintering takes place in a nitrogen atmosphere.

When treating a pellet of an Am-containing nitride in a high temperature nitrogen atmosphere, the loss of material due to evaporation is further prevented.

In another embodiment the heat treatment takes place in a high temperature furnace with controlled atmosphere. Preferably, also the heat treatment takes place in nitrogen atmosphere at approximately, but not more than, 1800 K for approximately 4-12 hours. Preferably, the temperature has some margin to the 1800 K temperature limit where americium is evaporated.

As mentioned above, if also the heat treatment takes place at a nitrogen atmosphere, the loss of material due to evaporation is even further prevented. Further, the heat treatment yields the desired single-phase solid solution pellet

### BRIEF DESCRIPTION OF DRAWINGS

The invention is now described, by way of example, with reference to the accompanying drawings, in which

FIG. 1 discloses a graph over the radiotoxic inventory of some radiotoxic isotopes over time.

FIG. 2 discloses a graph of the loss of americium as a function of temperature when sintering AmN.

### DESCRIPTION OF EMBODIMENTS

The invention is here described more in detail. All examples herein should be seen as part of the general description and therefore possible to combine in any way in general terms.

A high density pellet is to be understood as a pellet with a relative density of approximately 90% of the theoretical density.

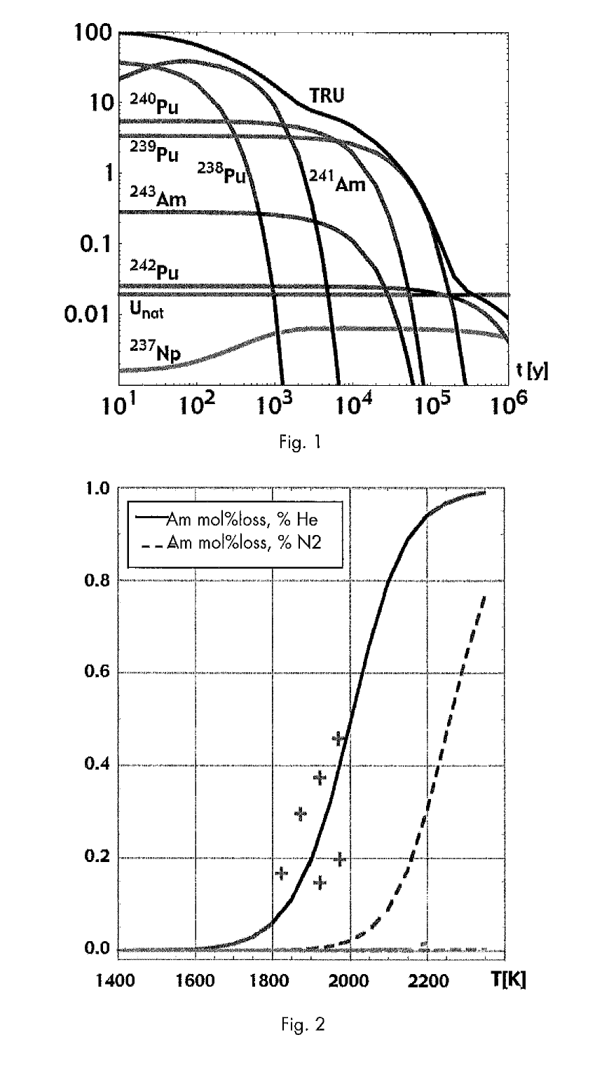

FIG. 1 discloses a graph over the radiotoxic inventory of some radiotoxic isotopes over time. In this graph it is visualized that plutonium and americium are the largest contributors to the long lived radio-toxicity in spent fuel from nuclear power plant. Today, these long-lived waste product must be stored in geologically isolated repositories for their radiotoxic lifetime. However, the invention discloses a method for reusing these isotopes in a nuclear fuel.

The method of producing said nuclear fuel comprises the following steps:
Mixing of the starting powders.
Sintering of the powders into a pellet, preferably by using current assisted compaction at high pressures.
Heat treatment The heat treatment preferably takes place in nitrogen atmosphere at 1800 K for several hours, such as 4-12 hours.

The starting powders are originally metals, nitrates or oxides of the different elements, which are converted, through various processes, to nitrides of the elements. The particle size is on the micrometer scale, preferably below 70 μm. Using a powder with a smaller dimension generally enables making the sintering at a lower sintering temperature, and is thus favorable. The mixing should take place in controlled atmosphere, such as in a glove box.

In a preferred embodiment the sintering takes place at a temperature of maximum 1800 K, under a pressure of 30-100 MPa, for a holding time of 2-30 min, preferably 2-15 min, by spark plasma sintering. The sintering parameters influence the density of the pellet The relative density should preferably be 90% -95% of the theoretical density.

In another embodiment the relative density should preferably be 85-95% of the theoretical density.

In one embodiment the porosity in the pellet is around 10%, and that allows a fuel burnup of around 10% if the fuel average temperature is 1100 K.

In another embodiment the sintering takes place at 1723 K during 3 minutes and at a pressure of 50 MPa and the obtained relative density is 90%. 1723 K gives a good margin to the temperature where AmN start to dissociate, and still gives desired density for the application.

Ina preferred embodiment the pellet is cylindrical with a diameter between 5 and 12 mm.

In another embodiment the pellet is cylindrical with a diameter of 10

The SFS sintering takes place in an electrically conducting sintering die, such as a for example, but not necessarily, a graphite die.

The heat treatment takes place in a high temperature furnace with controlled atmosphere. The atmosphere should preferably be a nitrogen based atmosphere, preferably with a partial pressure of nitrogen of approximately 10%. 1800 K is the limit for dissociation of Am in nitrogen, and is therefore the limiting temperature for the heat treatment

FIG. 2 discloses a graph of the mol % loss of americium as a function of temperature when sintering AmN. The dotted line in the graph visualizes that the loss of Am can be avoided if the temperature is kept below 1800 K and if the sintering takes place in a nitrogen based atmosphere. The full line curve shows the loss of Am in a helium based atmosphere. Here it is obvious that the sintering temperature has to be kept below 1600 K if no loss of Am shall occur. Thus, a nitrogen based atmosphere is preferred.

1.-16. (canceled)

17. A method for producing a nuclear fuel pellet of a material with a single-phase solid solution with a density of at least 85% of its theoretical density comprising at least a nitride of americium (Am), wherein the method comprises the following steps:
mixing starting powders comprising at least a nitride of americium (Am) and a nitride comprising elements belonging to the group of uranium (U), plutonium (PO zirconium (Zr) or curium (Cm),
sintering the powders into a pellet at a maximum temperature of 1800 K, and
heat treating the sintered pellet.

18. A method according to claim 17, wherein the starting powders originate, from metals, nitrates or oxides of americium, (Am), uranium (U), plutonium (Pu) zirconium (Zr) or curium (Cm), which are converted to nitrides of the elements.

19. A method according to claim 17, wherein the particle size of the starting powders is below 100 μm.

20. A method according to claim 17, wherein the particle size of the starting powders is below 70 μm.

21. A method according to claim 17, wherein the sintering method involves current assisted compaction at high pressures.

22. A method according to claim 21, wherein the sintering method involves spark plasma sintering.

23. A method according to claim 22, wherein the sintering takes place under a pressure of 30-100 MPa, for a holding time of approximately 2-30 min.

24. A method according to claim 23, wherein the sintering takes place under a pressure of 30-100 MPa, for a holding time of approximately 2-15 min.

25. A method according to claim 17, wherein the sintering takes place in an electronically conductive sintering die.

26. A method according to claim 17, wherein the sintering takes place in a nitrogen atmosphere.

27. A method according to claim 17, wherein the heat treatment takes place in a high temperature furnace with controlled atmosphere.

28. A method according to claim 27, wherein the heat treatment takes place in a nitrogen atmosphere.

29. A method according to claim 27, wherein the heat treatment takes place at approximately, but less than, 1800 K for approximately 4-12 hours.
